(19) United States
(12) Patent Application Publication
(10) Pub. No.: US 2006/0037695 A1
(43) Pub. Date: Feb. 23, 2006

(54) Method for producing plastic tanks for liquids

(76) Inventor: Udo Schutz, Selters/Westerwald (DE)

Correspondence Address: Friedrich Kueffner;Suite 910, 317 Madison Avenue, New York, NY, 10017, US

(21) Appl. No.: 11/203,662

(22) Filed: Aug. 12, 2005

(30) Foreign Application Priority Data
Aug. 18, 2004 (DE) 10 2004 039 963.8

(51) Int. Cl. B32B 37/00; B29C 65/00

(52) U.S. Cl. 156/304.1; 156/245; 156/256; 156/304.2

(57) ABSTRACT

A method for producing plastic tanks for liquids with a tapping valve, wherein the tank is produced from a tubular parison by blow molding, and wherein a holding flange or a threaded socket is formed on the tank. After the drain outlet of the tank has been cut out of the tank wall inside the holding flange or the threaded socket, the finished preassembled tapping valve is welded by its inlet socket to the holding flange or the threaded socket of the tank by a welding machine, during which the tank is centered and held in the welding machine by the holding flange or the threaded socket.

### BACKGROUND OF THE INVENTION

1. Field of the Invention

The present invention relates to a method for producing plastic tanks for liquids, especially for use as inner tanks for liquid shipping and storage tanks with an outer jacket in the form of a cage or sheet material and a pallet-like support frame, which are constructed as rectangular-solid or cubic tanks with four sidewalls, an upper base with a filling socket that can be closed with a cap, a lower base, and a drain outlet in the lower section of a sidewall for connection to a tapping valve.

2. Description of the Related Art

DE 102 42 954 A1 describes a method of this type for producing plastic tanks for liquids, in which the inlet connection of the tapping valve is welded to the blow-molded tank. This method has been found to be impracticable.

### SUMMARY OF THE INVENTION

The object of the invention is to develop a method with a high production capacity for producing plastic tanks for liquids that are equipped with a tapping valve.

In accordance with the invention, this object is met achieved by a production method in which the tanks are produced from a tubular parison by blow molding, wherein a holding flange or a threaded socket is formed on the rear section of a lower recess of the front wall of the tank, which recess receives the tapping valve. The recess of the tanks is cut out inside the holding flange or the threaded socket with a cutting tool to produce the drain outlet of the tanks. The finished preassembled tapping valve is welded to the holding flange or threaded socket in a welding machine.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of a shipping and storage tank for liquids constructed as a pallet tank; and

FIGS. 2 and 3 are enlarged views of the outlet region of the tank, half in a side view and half in a vertical section.

### DESCRIPTION OF THE INVENTION

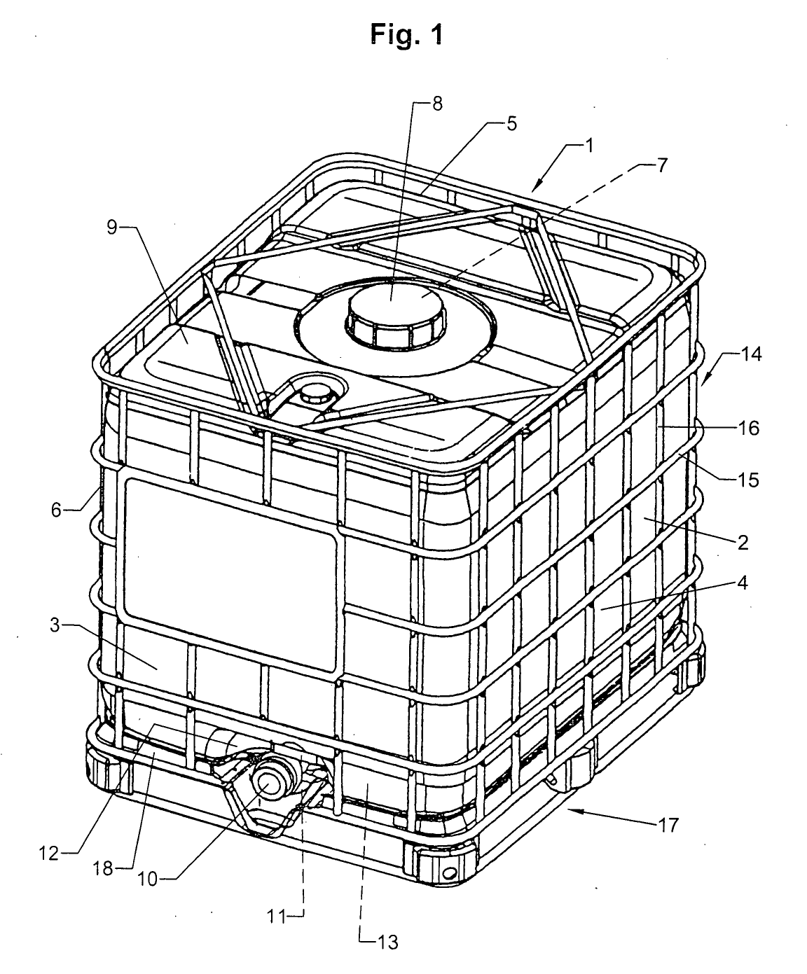

The shipping and storage tank 1 for liquids (FIG. 1), which can be used as a disposable and reusable tank, has as its principal components (1) a replaceable rectangular-solid plastic tank 2 for liquids with four sidewalls 3-6, which tank 2 has a filling socket 7 in the upper base 9 that can be closed with a cap 8 and a tapping valve 10, especially a flap valve, which is connected to a drain outlet 11 in a dome-shaped recess 12 in the front wall 3 of the tank 2 in the region of the lower base 13 of the tank for receiving the tapping valve 10, and (2) an outer cage 14 that consists of intersecting horizontal and vertical metal bars 15, 16 and a pallet-like support frame 17 with standard European dimensions of length and width, whose sheet-metal base 18, which is constructed as a shallow base pan, supports the plastic tank 2.

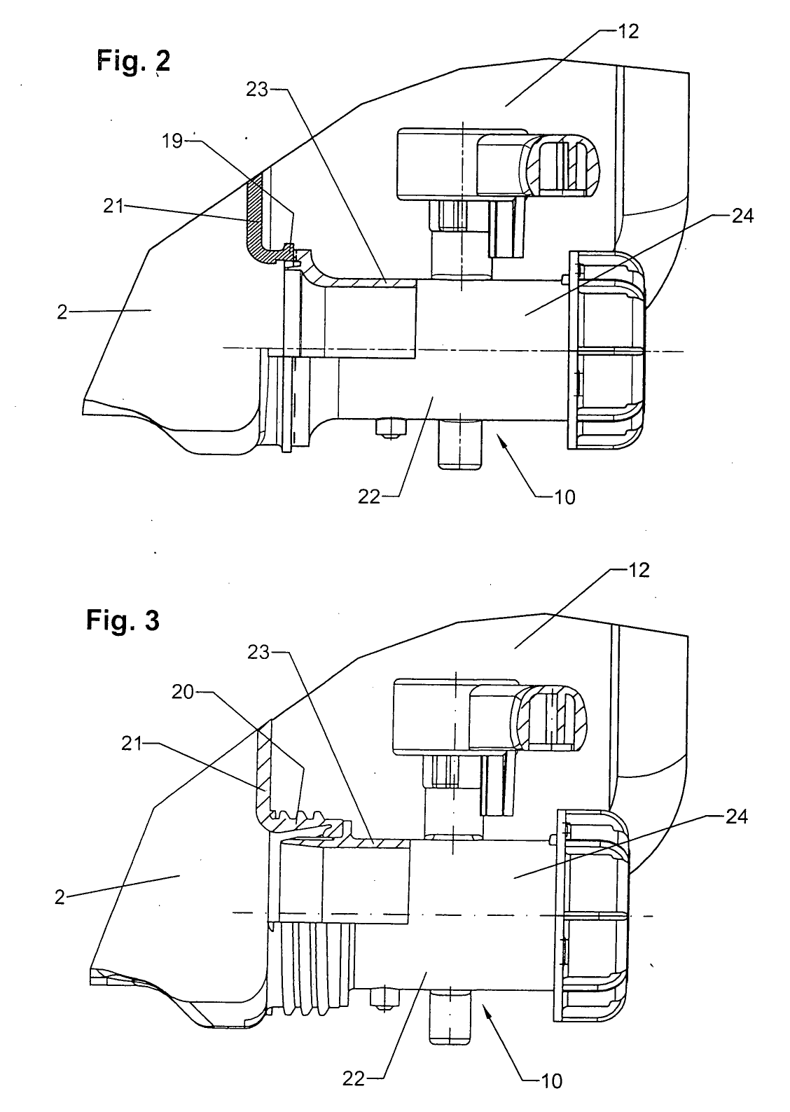

The tank 2 is produced from a tubular parison by blow molding, wherein a holding flange 19 (FIG. 2) or a threaded socket 20 (FIG. 3) is formed on the rear section 21 of a lower recess 12 of the front wall 3 of the tank 2, which recess 12 receives the tapping valve 10. After the tank 2 has cooled, its recess 12 is cut out inside the holding flange 19 or the threaded socket 20 with a cutting tool to produce the drain outlet 11 of the tank 2. The finished preassembled tapping valve 10, whose injection-molded plastic body 22 has an inlet socket 23 and an outlet socket 24, is then welded by its inlet socket 23 to the holding flange 19 or the threaded socket 20 of the tank 2 by a welding machine, especially a heat-reflection butt-welding machine, during which the tank 2 is centered and held in the welding machine by the holding flange 19 or the threaded socket 20.

While specific embodiments of the invention have been shown and described in detail to illustrate the inventive principles, it will be understood that the invention may be embodied otherwise without departing from such principles.

I claim:

1. A method for producing plastic tanks for liquids, especially for use as inner tanks for liquid shipping and storage tanks with an outer jacket in the form of a cage or sheet material and a pallet-like support frame, which are constructed as rectangular-solid or cubic tanks with four sidewalls, an upper base with a filling socket that can be closed with a cap, a lower base, and a drain outlet in the lower section of a sidewall for connection to a tapping valve, the method comprising producing the tanks from a tubular parison by blow molding, wherein a holding flange or a threaded socket is formed on the rear section of a lower recess of the front wall of the tank, which recess receives the tapping valve; cutting out the recess of the tanks inside the holding flange or the threaded socket with a cutting tool to produce the drain outlet of the tanks; and welding the finished preassembled tapping valve to the holding flange or threaded socket in a welding machine.

2. The method in accordance with claim 1, wherein, for welding the tapping valve to the tanks, centering the tanks and holding the tanks in the welding machine by the holding flange or the threaded socket.

3. Method in accordance with claim 1, comprising welding the inlet socket of the tapping valve to the holding flange or the threaded socket of the tanks by heat-reflection butt welding.
